(19) United States
(12) Patent Application Publication
(10) Pub. No.: US 2005/0127329 A1
(43) Pub. Date: Jun. 16, 2005

(54) Method of forming nanocomposite materials

(76) Inventors: Chyi-Shan Wang, Beavercreek, OH (US); Max D. Alexander JR., Centerville, OH (US)

Correspondence Address: DINSMORE & SHOHL LLP;One Dayton Centre, Suite 500, One South Main Street, Dayton, OH, 45402-2023, US

(21) Appl. No.: 10/789,295

(22) Filed: Feb. 27, 2004

Related U.S. Application Data
(63) Continuation-in-part of application No. 10/698,218, filed on Oct. 31, 2003.
Application No. 10/698,218 is a division of application No. 09/932,169, filed on Aug. 17, 2001, now Pat. No. 6,680,016.

(51) Int. Cl. H01C 1/00

(52) U.S. Cl. 252/500

(57) ABSTRACT

A method of reinforcing a polymeric material with nanosize materials is provided in which materials such as vapor grown carbon nanofibers, carbon nanotubes, layered silicates, nanosize sphered silica, or graphite nanoparticles are combined with a polymer and a solvent to form a substantially homogeneous mixture, followed by removal of the solvent by evaporation or coagulation. Depending on the nanosize materials used, the resulting polymeric nanocomposite material exhibits high electrical and thermal conductivity, enhanced mechanical strength, abrasion resistance, reduced gas permeation, and/or dimensional stability.

### CROSS REFERENCE TO RELATED APPLICATIONS

This application is a continuation-in-part of U.S. patent application Ser. No. 10/698,218 filed Oct. 31, 2003, which application is a division of U.S. patent application Ser. No. 09/932,169 filed Aug. 17, 2001, now U.S. Pat. No. 6,680,016.

### BACKGROUND OF THE INVENTION

The present invention is directed to a nanocomposite material incorporating uniformly dispersed nanosize materials, and to a method of forming such a nanocomposite material.

It is known that nanosize materials such as vapor-grown carbon nanofibers or carbon nanotubes may be used to enhance the mechanical, electronic and thermal transport properties of polymers and other high-performance plastics for use in a variety of applications. For example, vapor-grown carbon nanofibers have been dispersed in polymer matrices by a polymer melt blending method in which the dispersants in the polymer matrix are mechanically sheared apart. See, for example, U.S. Pat. No. 5,643,502. As nanosize materials tend to clump together, this reduces the benefit of their properties when they are incorporated into the polymer matrix. And, as most polymers are incompatible with nanosize materials such as carbon nanofibers, it is difficult to achieve uniform dispersion of the materials in the polymer matrix. In addition, the use of high shear mechanical blending can result in the breakage of the carbon nanofibers.

Accordingly, there is still a need in the art for an improved method of reinforcing a polymeric material with nanosize materials such as carbon nanofibers and carbon nanotubes as well as other nanosize materials which provides a uniform dispersion of the nanosize materials in the polymer matrix and which produces a nanocomposite material having maximum attainable improvement in various mechanical, electrical, and thermal properties.

### SUMMARY OF THE INVENTION

The present invention meets that need by providing a method for uniformly dispersing nanosize materials such as vapor-grown carbon nanofibers, carbon nanotubes, silicas, silicates and graphite nanoparticles into polymer matrices which enhances their mechanical strength, dimensional stability, abrasion resistance, and electrical and thermal conductivity. The uniform dispersion of such nanosize materials in a polymer matrix is achieved by dissolving the polymer in a solvent with the nanosize material to achieve a substantially homogeneous solution, followed by evaporation or coagulation of the solvent.

According to one aspect of the present invention, a method of forming a polymeric nanocomposite material is provided comprising providing a nanosize material selected from the group consisting of vapor grown carbon nanofibers, carbon nanotubes, layered silicates, nanosize sphered silica, and graphite nanoparticles. The nanosize material is combined with a solvent to form a solution mixture, and a polymer is added to the solution mixture to form a substantially homogeneous mixture. The solvent is then removed from the mixture, preferably by evaporation or coagulation.

In an alternative embodiment of the invention, the method may comprise combining the nanosize material, polymer, and solvent together to form a substantially homogeneous mixture, followed by removal of the solvent.

In another embodiment of the invention, the method includes adding a dispersing agent selected from the group consisting of oils, plasticizers, and surfactants to the solution mixture. The dispersing agent is preferably added to the mixture to facilitate dispersion of the materials.

In yet another embodiment of the invention where the polymer is a thermosetting polymer, the method may include adding a curing agent after removing the solvent from the mixture. The curing agent is selected from the group consisting of amines and metallic catalysts.

The polymer used in the present invention is preferably selected from the group consisting of polyurethanes, polyolefins, polyamides, polyimides, epoxy resins, silicone resins, polycarbonate resins, acrylic resins, and aromatic-heterocyclic rigid-rod and ladder polymers.

The solvent is preferably selected from the group consisting of dimethyl sulfoxide, tetrahydrofuran, acetone, methylene chloride, toluene, xylene, sulfuric acid, methanesulfonic acid, polyphosphoric acid, N,N-dimethyl acetamide, butyl acetate, water and mixtures thereof. Preferably, both the polymer and the solvent for the polymer are compatible with the nanosize material.

The vapor grown carbon nanofibers used in the present invention may comprise as-grown fibers, pyrolytically stripped fibers, or heat treated fibers. The carbon nanotubes used in the present invention may comprise single-walled or multi-walled nanotubes.

Where the method of the present invention utilizes a nanosize material comprising vapor grown carbon fibers, carbon nanotubes, or graphite nanoparticles, a conductive polymeric nanocomposite material is formed having an electrical conductivity ranging from less than 0.001 S/cm to greater than 400 S/cm.

In another embodiment of the invention, the method of forming a polymeric nanocomposite material comprises providing a nanosize material selected from nanosize sphered silica and layered silicates, providing a polymer comprising a thermoplastic or thermosetting resin; combining the nanosize material and polymer with a solvent to form a substantially homogeneous mixture, and removing the solvent from the mixture. Preferably, the thermoplastic or thermosetting resin is selected from the group consisting of epoxies, silicones, polyolefins, polycarbonates, and acrylics. The solvent is preferably removed from the mixture by evaporation. Where the polymer comprises a thermosetting resin, the method preferably includes adding a curing agent after removal of the solvent from the mixture. The curing agent is preferably selected from the group consisting of amines and metallic catalysts.

The polymeric nanocomposite materials formed by the method of the present invention may be used to form paints, coatings, caulks, sealants, adhesives, fibers, thin films, thick sheets, tubes, and large structural components. The nanosize materials in the resulting nanocomposite materials may be used to confer the desired mechanical strength, stiffness, dimensional stability, thermal conductivity, electrical conductivity, reduced gas permeation, and tribological properties (i.e., reduced surface friction) in such products.

The nanocomposite materials may be used in a wide variety of commercial applications including space, aerospace, electronic, automotive, and chemical industries. The nanocomposite materials may also be used in electromagnetic interference shielding, electromagnetic pulse applications, electrical signal transfer, electrostatic painting of panels, electrostatic discharge and electro-optical devices such as photovoltaic cells.

Accordingly, it is a feature of the present invention to provide a method of forming a polymeric nanocomposite material which results in uniform dispersion of nanosize materials in a polymeric matrix. Other features and advantages of the invention will be apparent from the following description and the appended claims.

### BRIEF DESCRIPTION OF THE DRAWINGS

FIG. 1 is a graph illustrating the improved tensile strength of the nanocomposite material formed by the method of the present invention; and

FIGS. 2A-2C are graphs illustrating the modulus, thermal conductivity, and resistivity of nanocomposite materials formed by the method of the present invention.

### DETAILED DESCRIPTION OF THE PREFERRED EMBODIMENTS

We have found that the method of the present invention is more effective in uniformly dispersing nanosize materials into polymer matrices than prior art methods such as melt blending. By “uniformly dispersed,” it is meant that the nanosize materials are uniformly dispersed throughout the polymer matrix with minimal degradation of their large aspect ratio. The method of the present invention achieves uniform dispersion of nanosize materials in polymer matrices by dissolving the polymer in a solvent with the nanosize materials. While the nanosize materials of the present invention alone do not disperse well in organic solvents, we have found that they disperse very well in the presence of a polymer. Accordingly, the nanosize materials are combined with the polymer and solvent to form a substantially homogeneous mixture, followed by evaporation or coagulation of the solvent to form the polymeric nanocomposite material. By “substantially homogeneous mixture”, it is meant that the nanosize materials are uniformly dispersed in the solution mixture.

After the solvent is removed, the resulting polymer nanocomposite material can be further processed into various shapes and forms by conventional polymer extrusion and molding techniques.

The method of the present invention provides another advantage over prior melt-blending processes in that it utilizes a low-temperature solution process, (i.e., no heat is required to melt the polymer) to disperse the nanosize materials. The method does not require high shear mixing of the polymer melt at elevated temperatures, which typically degrades the aspect ratio of nanosize materials such as carbon nanofibers or nanotubes and can cause clumping or poor uniformity of nanosize materials such as layered silicates, sphered silica, and graphite, leading to inferior physical properties of the resulting composite.

However, it should be appreciated that while the use of high shear mixing is not required in the method of the present invention, it may be desirable to use high shear when mixing nanosize materials such as graphite nanoparticles or layered silicates and nanosize sphered silica to accelerate the mixing of the components to achieve a homogeneous mixture.

Where the nanosize materials comprise vapor grown carbon nanofibers, carbon nanotubes, or graphite nanoparticles, the resulting polymer nanocomposite material produced by the method of the present invention is conductive. We have found that the resulting polymer nanocomposite material has a very low electronic conducting percolation threshold of less than 1% by volume of the nanosize material, which is indicative of an extremely large aspect ratio of the nanosize material. This also indicates that the method of the present invention is more effective in uniformly dispersing the nanosize material in the polymer matrices and preserving a large aspect ratio of length to diameter of the nanosize material than prior polymer melt blending methods. It is important to maintain the large aspect ratio of the nanosize material to confer maximum attainable reinforcement, especially for applications such as the use of elastomeric polymers for forming gaskets or seal structures.

The conductivity of the polymeric nanocomposite material may be tailored, depending on the desired application, from less than 0.001 S/cm to greater than 400 S/cm. Where the conductive polymeric nanocomposite material is incorporated with single-walled carbon nanotubes, the nanocomposite material may have an electrical conductivity greater than 400 S/cm at 60 wt % loading, while materials incorporated with low concentrations of as-grown or pyrolytically stripped carbon nanofibers or graphite nanoparticles may be tailored to have an electrical conductivity smaller than about 10⁻⁶ S/cm. It should be appreciated that the mechanical and thermal properties of the resulting polymer nanocomposite material may be tailored by using different types and amounts of the nanosize materials.

Where the nanosize materials comprise layered silicates or nanosize sphered silica, the resulting polymeric nanocomposite material has improved dimensional stability.

Suitable polymers for use in the present invention include various thermoplastic and thermosetting polymers; however, it should be appreciated that any polymer may be used in the present invention as long as it is soluble in a solvent. Preferred polymers include polyurethanes, polyolefins, polyamides, polyimides, epoxy resins, silicone resins, polycarbonate resins, acrylic resins, and aromatic-heterocyclic rigid-rod and ladder polymers such as poly(benzimidazobenzophenanthroline) (BBL). The polymer is preferably present in a concentration of at least 10 wt %; however, it should be appreciated that the concentration of the polymer may vary depending on the desired properties and applications, such as coatings, of the resulting composite material.

In embodiments where the nanosize material comprises nanosize sphered silica or layered silicates, the polymer preferably comprises a thermoplastic or thermosetting resin such as an epoxy resin or silicone resin, a polyolefin, or polycarbonate or acrylic resins. Preferred epoxy resins for use in the present invention include Epon 862 or Epon 828, commercially available from Shell Chemical Co. Preferred silicone resins include Dow Corning Silastic GP30 or Q2901. Preferred layered silicates and nanosize sphered silica for use in the present invention are commercially available from Southern Clay Products and Nanocore.

In embodiments where the polymer comprises a thermosetting resin, a curing agent is preferably added after removing the solvent from the mixture to cure the resin. Suitable curing agents for use in the present invention include amines and metallic catalysts. Preferred amines include multi-functional amines. A preferred metal catalyst is platinum. An optional coupling agent may also be added, and preferably comprises 3-glycidoxypropylmethoxy silane. After addition of the curing agent, the resin may be cured using UV radiation or heat to form the resulting nanocomposite material.

Preferred solvents for use in the present invention include, but are not limited to, dimethyl sulfoxide, acetone, tetrahydrofuran, methylene chloride, sulfuiric acid, toluene, xylene, N,N-dimethyl acetamide, methanesulfonic acid, polyphosphoric acid, butyl acetate, water, and mixtures thereof.

When the nanosize material comprises vapor grown carbon nanofibers, the nanofibers are preferably prepared in accordance with U.S. Pat. No. 6,156,256, incorporated herein by reference. Several types of carbon nanofibers may be used in the present invention including as-grown fibers, pyrolytically stripped fibers, and heat treated fibers. By heat treated fibers, it is meant that the nanofibers are fully graphitized by slowly heating the fibers to 3,000° C. and then slowly cooling the fibers. It has been found that when carbon nanofibers are heat treated, the order of the surface chemical-vapor-deposited carbon is highly increased, resulting in substantially improved mechanical, electronic, and thermal transport properties. Heat-treated carbon nanofibers have an electrical conductivity close to that of highly ordered pyrolytic graphite and a thermal conductivity which is five times as high as that of copper. Heat treated fibers are preferred in applications where high conductivity and low carbon nanofiber loading are desired.

The use of carbon nanofibers also results in a nanocomposite having a thermal conductivity which is about ten times greater than the neat resin. For example, carbon nanofibers used to reinforce a polymer comprising an epoxy resin have exhibited thermal conductivities ranging from 0.5 W/m·K up to about 2.8 W/m·K.

The carbon nanotubes used in the present invention may comprise single-walled or multi-walled nanotubes. Preferred single-walled nanotubes are available from Rice University. Preferred multi-walled nanotubes are available from Applied Sciences Inc.

The method of the present invention is preferably carried out by mixing the nanosize material and the desired polymer in a solvent, preferably in a closed container. While the nanosize material is preferably dispersed in the solvent prior to addition of the polymer, it should be appreciated that the nanosize material, polymer and solvent may also be combined at the same time. The preferred method of combining the components will vary depending on the solubility of the polymer being used.

In the method of preparing the nanocomposite, it may be desirable to include a dispersing agent when mixing the nanosize material with the polymer and solvent to ensure a uniform dispersion of the materials. Suitable dispersing agents for use in the present invention include oils, plasticizers, and various surfactants. Suitable oils include vegetable and mineral oils including, but not limited to, castor oils, modified castor oils, soybean oils, modified soy bean oils, rape seed and canola oils, mineral oils, petroleum greases and lubricants. Suitable plasticizers include adipates, esters, oleates, phthalates, epoxides, and polymeric and monomeric plasticizers commonly used in industrial and specialty applications.

The resulting nanocomposite material may be further processed according to the desired application. For example, where the nanosize material comprises carbon nanofibers and nanotubes, the nanocomposite material may be formed into a thin film which is cast from the solution mixture by evaporating the solvent at a temperature which is at or below the boiling point of the solvent. Alternatively, the solvent may be removed by coagulation in which the solution mixture is formed into a film or fiber and then immersed in a nonsolvent, such as water, to coagulate the film. The solution mixture may also be formed into thin films by spin coating and dip coating methods. The solution mixture may also be formed into large components such as thick sheets or panels by spraying or deposition, or by extruding or molding the dried composite material.

Where the nanosize material comprises graphite nanoparticles, the nanocomposite material may be formed into films, sheets, extruded shapes, coatings, inks, adhesives, molded parts and large structural components.

Where the nanosize material comprises layered silicates or nanosize sphered silica, the nanocomposite material may be formed into structural adhesives, coatings, inks, films, extruded shapes, thick sheets, molded parts, and large structural components.

In order that the invention may be more readily understood, reference is made to the following examples which are intended to illustrate the invention, but not limit the scope thereof.

### EXAMPLE 1

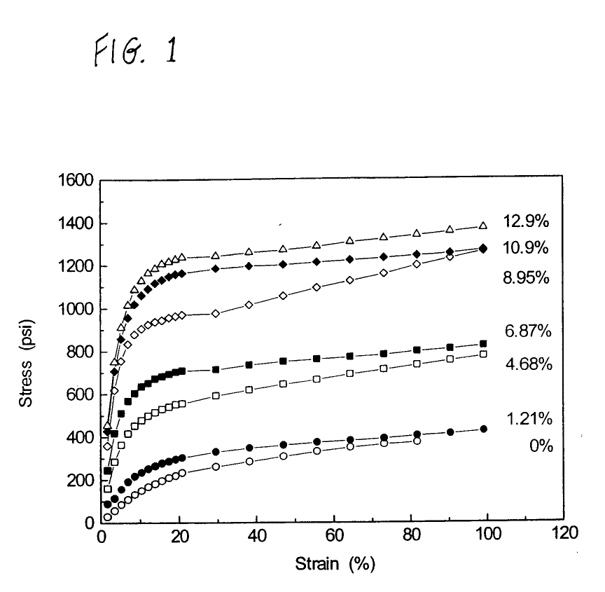

A nanocomposite material was prepared using various volume fractions (see FIG. 1) of vapor grown carbon nanofibers with a thermoplastic polyurethane polymer and tetrahydrofuran (THF). The solvent was removed by evaporation. FIG. 1 illustrates a stress-strain curve of the nanocomposite material as a function of the carbon nanofiber content. The curve illustrates that the tensile strength of the nanocomposite is increased from about 400 psi (no carbon nanofibers) to about 1400 psi when including 12.9% by volume of the carbon nanofibers.

### EXAMPLE 2

A nanocomposite material was formed from polyurethane and carbon nanofibers in tetrahydrofuran (THF). The solvent was removed by evaporation. The abrasion resistance of the resulting nanocomposite was determined using a Plint friction test. A roller pin of 6mm×6 mm with a load of 550 g (5.4 Newton) was used for the test. The roller pin moved on the composite film with a stroke of 9 mm and a frequency of 2 Herz. The following Table 1 demonstrates that the film which contained no carbon nanofibers was torn in approximately 3 minutes, while the films which contained carbon nanofibers remained intact after 30 minutes of the test.

TABLE 1

| | carbon nanotubes | | | |
|---|---|---|---|---|
| Sample | (wt %) | Friction (N) | Coefficient | Time (min.) |
| 1 | 0 | 3.8 | 0.70 | ˜3 |
| 2 | 0 | 4.1 | 0.76 | >30 |
| 3 | 16.6 | 3.6 | 0.67 | >30 |
| 4 | 16.6 | 3.7 | 0.69 | >30 |
| 5 | 28.8 | 2.3 | 0.43 | >30 |
| 6 | 28.8 | 2.4 | 0.44 | >30 |

### EXAMPLE 3

6 grams of single-wall carbon nanotubes were obtained from Rice University and dispersed in a solvent comprising a mixture of 50% fuming sulfuric acid and 50% polyphosphoric acid in a Haake mixer at 180° C. for 30 minutes. 4 grams of a rigid-rod polymer poly(p-phenylene benzobisthiazole) was added to the mixture and mixed for one hour. The resulting solution mixture was transferred into an extrusion vessel and extruded into a fiber at 160° C. through a spinneret of 510 μm diameter. The fiber was coagulated in distilled water to remove the acids. After the fiber was thoroughly washed with watter, it was air dried. The dry fiber was also heat-treated under tension at 500° C. and 600° C., respectively. The fiber exhibited a diameter of 80 to 100 μm, a tensile strength of about 26 Kpsi, a Young's modulus of 1.8 Mpsi, and an electrical conductivity as high as 400 S/cm.

### EXAMPLE 4

Polymeric nanocomposites were prepared using exfoliated graphite nanoparticles as the nanosize material. The first sample was prepared in accordance with the method of the present invention. The exfoliated graphite nanoparticles were added to acetone and then mechanically sheared at 20,000 RPM with a shear mixer. An epoxy resin was then added to the mixture. The acetone was driven off by evaporation using the combination of a sonic bath and a mechanical mixing device. After all of the acetone was driven off, the batch was then placed in a silicon mold and degassed in a vacuum oven. The nanocomposite was then molded by hot pressing.

The second sample was prepared without the use of a solvent and without the use of shear mixing. The sample was added to an epoxy resin and cast into a mold.

A three point bending test was used to determine the mechanical properties of the nanocomposite samples using ASTM D 790-00. The electrical properties were measured using standard 4 probe techniques. As shown in Table 2, Sample 1 prepared in accordance with the method of the present invention exhibited higher mechanical strength than Sample 2 which was prepared without the use of a solvent or shearing to facilitate a homogeneous mixture.

TABLE 2

| | Modulus | | | |
|---|---|---|---|---|
| | (Gpa) | Std. deviation | Yield Stress | Std. deviation |
| Sample 1 | 2.43 | 0.0462 | 0.071 | 0.0025 |
| Sample 2 | 1.93 | 0.225 | 0.025 | 0.0115 |

It can be seen that there is a much higher standard deviation in the sample which was mixed without shear, which indicates that the graphite particles were not adequately dispersed. To validate this assumption, an electrical measurement was carried out at different locations within the same sample. The results are shown below in Table 3.

TABLE 3

| Sample | Resistivity (Ohm-cm) |
|---|---|
| Sample prepared using method of invention | |
| location 1 | 6.8 × 10⁴ |
| location 2 | 7.4 × 10⁴ |
| location 3 | 1.5 × 10⁵ |
| location 4 | 9.3 × 10⁴ |
| Sample prepared without solvent/shearing | |
| location 1 | 7.1 × 10³ |
| location 2 | 4.5 × 10⁶ |
| location 3 | 2.35 × 10² |
| location 4 | 5.55 × 10⁹ |
| location 5 | 3.28 × 10⁸ |

As can be seen, the electrically resistivity for the sample prepared in accordance with the present invention is very consistent at all locations and averages around 8×10⁴ Ohm-cm, while the electrical resistivity for the comparative sample varies greatly from one location to another, changing from 100 to 1000 orders of magnitude.

### EXAMPLE 5

Samples of sphered-silica epoxy nanocomposites and layered silicate epoxy nanocomposites were formed using the method of the present invention in which sphered silica nanoparticles or nanosheets of layered silicate were combined with acetone followed by the addition of an epoxy resin (Epon 862 or Epon 828 from Shell), a curing agent (Jeffamine® from Huntsman Chemical) with or without a coupling agent (3-glycidoxypropyltrimethoxy silane).

The introduction of nanosize sphered silica into the epoxy resin resulted in good dispersion without significant precipitation.

The dispersion of the nanosheets in the epoxy resin matrix was very good. Using transmission electron microscopy, it was determined that the individual nanosheets were dispersed homogeneously and continuously in the epoxy matrix.

### EXAMPLE 6

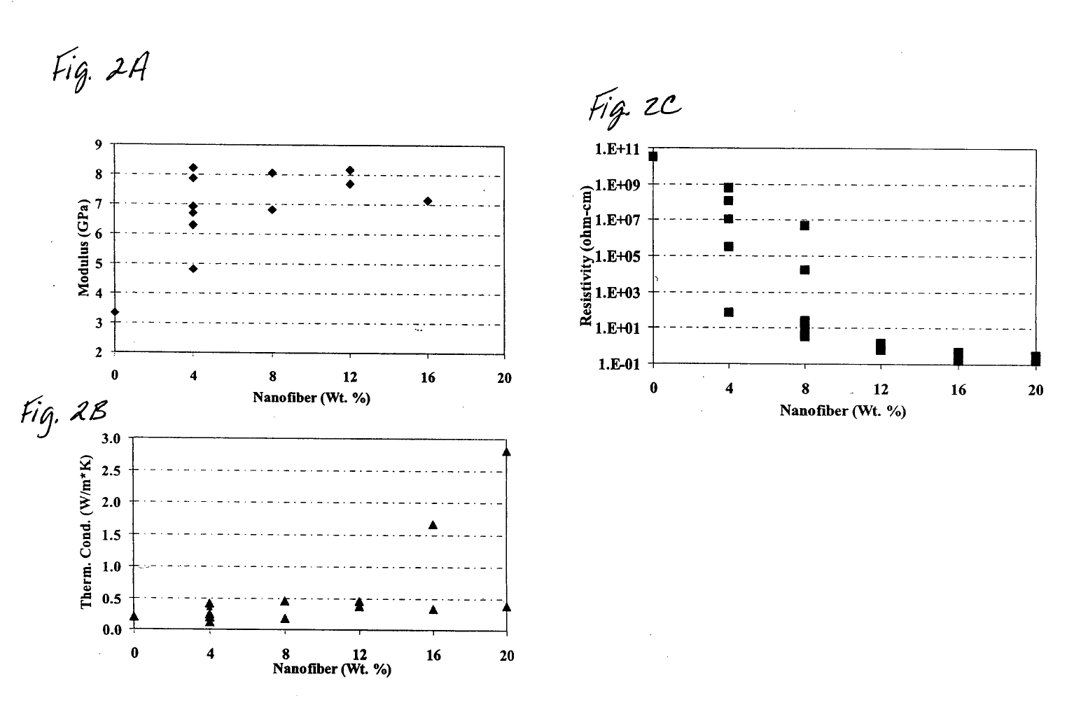

Various nanocomposite materials were formed using various loadings of carbon nanofibers which were combined with acetone followed by the addition of an epoxy resin in accordance with the method of the present invention. The solvent was evaporated and a curing agent was added. FIGS. 2A, 2B and 2C which illustrate the modulus, thermal conductivity, and electrical resistivity of the resulting nanocomposite material.

It will be obvious to those skilled in the art that various changes may be made without departing from the scope of the invention which is not to be considered limited to what is described in the specification.

1. A method of forming a polymeric nanocomposite material comprising:
providing a nanosize material;
combining said nanosize material with a solvent to form a solution mixture;
adding a polymer to said solution mixture to form a substantially homogeneous mixture; and
removing said solvent from said mixture.

2. The method of claim 1 wherein said nanosize material is selected from the group consisting of vapor grown carbon nanofibers, carbon nanotubes, layered silicates, nanosize sphered silica, and graphite nanoparticles.

3. The method of claim 1 in which said solvent is removed by evaporation.

4. The method of claim 1 in which said solvent is removed by coagulation.

5. The method of claim 1 in which said polymer is selected from the group consisting of polyurethanes, polyolefins, polyamides, polyimides, epoxy resins, silicone resins, polycarbonate resins, acrylic resins, and aromatic-heterocyclic rigid-rod and ladder polymers.

6. The method of claim 1 in which said solvent is selected from the group consisting of dimethyl sulfoxide, tetrahydrofuran, acetone, methylene chloride, toluene, xylene, sulfuric acid, methanesulfonic acid, polyphosphoric acid, N,N-dimethyl acetamide, butyl acetate, and mixtures thereof.

7. The method of claim 2 in which said vapor grown carbon nanofibers are selected from the group consisting of as-grown fibers, pyrolytically stripped fibers, and heat treated fibers.

8. The method of claim 2 wherein said carbon nanotubes comprise single-walled or multi-walled nanotubes.

9. The method of claim 1 including adding a dispersing agent to said solution mixture selected from the group consisting of oils, plasticizers, and surfactants.

10. The method of claim 1 including adding a curing agent after removing said solvent from said mixture.

11. The method of claim 10 wherein said curing agent is selected from the group consisting of amines and metallic catalysts.

12. A method of forming a polymeric nanocomposite material comprising:
providing a nanosize material selected from nanosize sphered silica and layered silicates;
providing a polymer comprising a thermoplastic or thermosetting resin;
combining said nanosize material and said polymer with a solvent to form a substantially homogeneous mixture; and
removing said solvent from said mixture.

13. The method of claim 12 wherein said thermoplastic or thermosetting resin is selected from the group consisting of epoxies, silicones, polyolefins, polycarbonates, and acrylics.

14. The method of claim 12 including adding a curing agent after removing said solvent from said mixture.

15. The method of claim 14 wherein said curing agent is selected from the group consisting of amines and metallic catalysts.

16. The method of claim 12 wherein said solvent is removed by evaporation.

17. The method of claim 12 including adding a dispersing agent selected from the group consisting of oils, plasticizers, and surfactants when combining said nanosize material, polymer, and solvent.

18. A method of forming a polymeric nanocomposite material comprising:
providing a nanosize material;
providing a polymer;
combining said nanosize material and said polymer with a solvent to form a substantially homogeneous mixture; and
removing said solvent from said mixture.

19. The method of claim 18 wherein said nanosize material is selected from the group consisting of vapor grown carbon nanofibers, carbon nanotubes, layered silicates, nanosize sphered silica, and graphite nanoparticles.

20. The method of claim 18 wherein said polymer is selected from the group consisting of polyurethanes, polyolefins, polyamides, polyimides, epoxy resins, silicone resins, polycarbonate resins, acrylic resins, and aromatic-heterocyclic rigid-rod and ladder polymers.
